(19) United States
(12) Patent Application Publication
(10) Pub. No.: US 2017/0233222 A1
(43) Pub. Date: Aug. 17, 2017

(54) ELEVATOR

(71) Applicant: KONE Corporation, Helsinki (FI)

(72) Inventor: Mikko PURANEN, Riihimäki (FI)

(73) Assignee: KONE Corporation, Helsinki (FI)

(21) Appl. No.: 15/395,224

(22) Filed: Dec. 30, 2016

(30) Foreign Application Priority Data
Feb. 15, 2016 (EP) 16155671.7

(51) Int. Cl. B66B 5/02; B66B 5/00; B66B 1/32; B66B 7/12; B66B 9/00; B66B 1/30

(52) U.S. Cl. CPC B66B 5/02; B66B 9/00; B66B 1/30; B66B 1/32; B66B 7/1223; B66B 5/0018

(57) ABSTRACT

An elevator includes an elevator car; a counterweight; one or more ropes interconnecting the car and counterweight, one end of each rope being fixed to the counterweight, and each rope comprising one or more electrically conductive load bearing members that extend unbroken throughout the length of the rope embedded in a non-conductive surface material; a monitoring circuit comprising at least two of said electrically conductive load bearing members of the one or more ropes connected in series, and one or more connectors mounted on the counterweight and connecting ends of said at least two electrically conductive load bearing members in series, said one or more connectors comprising a switch that is movable between a conductive and a non-conductive state, whereby the state change of the switch is arranged to change conductivity of the monitoring circuit; a monitoring system connected with the monitoring circuit and arranged to monitor the state of the monitoring circuit; and a counterweight position sensor mounted on the counterweight, and arranged to sense position of the counterweight. The switch and the counterweight position sensor are connected, and the state of the switch is arranged to change in response to position change of the counterweight sensed by the counterweight position sensor. The elevator is arranged to perform one or more predetermined actions in response to a state change of the monitoring circuit.

### FIELD OF THE INVENTION

The invention relates to an elevator. Said elevator is preferably an elevator for vertically transporting passengers and/or goods.

### BACKGROUND OF THE INVENTION

In counterweighted elevators, the counterweight travels along guide rails. It is possible that the counterweight gets derailed from its intended path as a result of damages of its guide equipment or in case of earthquake, for example. Such a derailment would cause a safety risk. In elevators of prior art, the elevator has been protected from derailment with a derailment detection system of the counterweight. A known system comprises a ring on the counterweight that is moved around a string installed in the elevator hoistway, keeping the string out of contact with the string. If the ring touches the string, the string gets electrically grounded, which triggers an alarm. In steel rope elevators, the ring of the derailment detector is grounded via rope terminals, hoisting ropes and traction sheave. A drawback of this system is that it does not suit well with elevators where the ropes are coated, because the coating acts as an insulator. A drawback of this system is also that it requires installing a string into the hoistway, which consumes space and prolongs the total installation time of the elevator.

### BRIEF DESCRIPTION OF THE INVENTION

The object of the invention is to introduce an elevator that is improved in terms of its ability to monitor counterweight safety. An object is to introduce a solution by which incorrect counterweight position and particularly lateral derailment thereof can be observed and reacted to in an appropriate fashion. An object is to introduce a solution by which one or more of the above defined problems of prior art and/or problems discussed or implied elsewhere in the description can be solved. Embodiments are presented, inter alia, where one or more of the above objects are realized with simple overall structure and good reliability.

It is brought forward a new elevator comprising an elevator car; a counterweight; one or more ropes interconnecting the car and counterweight, one end of each rope being fixed to the counterweight, and each rope comprising one or more electrically conductive load bearing members that extend unbroken throughout the length of the rope embedded in a non-conductive surface material; and a monitoring circuit comprising at least two of the electrically conductive load bearing members of the one or more ropes connected by one or more connectors in series, and one or more connectors mounted on the counterweight and connecting ends of said at least two electrically conductive load bearing members in series, said one or more connectors comprising a switch that is movable between a conductive and a non-conductive state, whereby the state change of the switch is arranged to change conductivity of the monitoring circuit; and a monitoring system connected with the monitoring circuit and arranged to monitor the state of the monitoring circuit. The elevator further comprises a counterweight position sensor mounted on the counterweight, and arranged to sense position of the counterweight, in particular counterweight lateral position relative to guide rail. The switch and the counterweight position sensor are connected, e.g. mechanically or electrically, and the state of the switch is arranged to change in response to position change of the counterweight sensed by the counterweight position sensor. The elevator is arranged to perform one or more predetermined actions in response to state change of the monitoring circuit. With this solution one or more of the above mentioned objects are achieved. Preferable further details are introduced in the following, which further details can be combined with the elevator individually or in any combination.

In a preferred embodiment, said one or more predetermined actions include at least stopping the elevator car and/or preventing further starts of the elevator car. Thus, an unsafe condition can be prevented from progressing.

In a preferred embodiment, said state change of the circuit is a change in conductivity of the circuit. Preferably, the conductivity of the monitoring circuit is monitored by monitoring resistance of the circuit. Then, preferably the monitoring system of the elevator is arranged to monitor the state of the monitoring circuit by monitoring resistance of the circuit. However, also alternative electrical properties known in the electrical field can be used to monitor conductivity indirectly or directly, such as voltage or signal throughput etc.

In a preferred embodiment, the monitoring system of the elevator is arranged to perform said one or more predetermined actions in response to state change of the monitoring circuit.

In a preferred embodiment, the monitoring system comprises a monitoring unit connected with the monitoring circuit. The monitoring unit is preferably mounted on the elevator car, wherefrom it can simply connect to the monitoring circuit. Said monitoring unit is preferably connected with an elevator control unit of the elevator and/or a safety circuit of the elevator.

In a preferred embodiment, the monitoring system is arranged to supply electricity to the monitoring circuit. Thereby change of state of the monitoring circuit, such as change in conductivity of the monitoring circuit, will be detectable. Said supply can be continuous or intermittent, for example. Preferably, the monitoring system comprises a monitoring unit connected with the monitoring circuit and arranged to supply electricity to the circuit. Thereby change in conductivity of the monitoring circuit will be simply detectable. Said supply can be continuous or intermittent. Said monitoring unit is preferably mounted on the elevator car as above mentioned.

In a preferred embodiment, said counterweight position sensor is arranged to sense lateral position of the counterweight relative to a guide rail guided by which the counterweight is arranged to travel.

In a preferred embodiment, the switch and the counterweight position sensor are connected by a mechanical linkage that can actuate the switch to change its state.

In a preferred embodiment, said counterweight position sensor comprises one or more sensing members arranged to travel together with the counterweight along the guide rail.

In a preferred embodiment, said one or more sensing members travel together with the counterweight along the guide rail out of contact with the guide rail.

In a preferred embodiment, each of the sensing members is displaceable by the guide rail if the guide rail pushes the sensing member when their relative position changes.

In a preferred embodiment, each of the sensing members is connected with the switch by a mechanical linkage by which the sensing member is arranged to actuate the switch to change its state when displaced. The mechanical linkage can be implemented in various ways as it is apparent to the skilled person. It can contain for example one or more force transmission members connected to each other, such as one or more force transmission rods and/or one or more force transmission pivots for transmitting force from the counterweight position sensor to the switch.

In a preferred embodiment, said one or more connectors include a further connector parallel with the switch. Preferably, said further connector is a resistor. Preferably, said one or more actions include one or more first actions in response to a first predetermined state change, and one or more second actions in response to a second predetermined state change, wherein said first and second predetermined state changes are different from each other. Preferably, said first predetermined change of the monitoring circuit is or at least corresponds to drop of conductivity of the monitoring circuit by a predetermined amount or a drop to a predetermined non-zero value, wherein said predetermined non-zero value is a value received with intact monitoring circuit said switch in open state, and said second predetermined change of the circuit is or at least corresponds to drop of conductivity of the monitoring circuit to zero or to some other non-zero value than said predetermined non-zero value. By selection of the resistor, the conductivity of the monitoring circuit when intact can be set to a desired level. Preferably, said one or more first actions include indicating that counterweight derailment has occurred and said one or more second actions include indicating that rope damage or cable disconnection has occurred.

In a preferred embodiment, the counterweight has been mounted to travel along guide rails guided by guide members mounted on the counterweight. Preferably, said counterweight position sensor does not guide the counterweight. However, this is not necessary as it is also possible to combine these functions.

In a preferred embodiment, each said rope is belt-shaped, i.e. it is substantially larger in its width direction than in its thickness direction. Preferably, the belt-shaped rope comprises plurality of load bearing members adjacent each other in width direction of the rope, isolated from each other by the non-conductive surface material, and said at least two load bearing members belong to said plurality of load bearing members of the same belt shaped rope.

In a preferred embodiment, each said load bearing member comprises plurality of conductive elongated members, such as fibers.

In a preferred embodiment, each said load bearing member is made of composite material comprising conductive reinforcing fibers embedded in polymer matrix, said reinforcing fibers preferably being carbon fibers.

In a preferred embodiment, the electrically conductive load-bearing member(s) of the rope cover(s) over proportion 50% of the cross-section of the rope. Thereby, a high tensile stiffness can be facilitated.

In a preferred embodiment, the electrically conductive load-bearing member(s) of the rope cover(s) majority, preferably 60% or over, more preferably 65% or over of the width of the rope. In this way at least majority of the width of the rope will be effectively utilized and the rope can be formed to be light and thin in the bending direction for reducing the bending resistance.

In a preferred embodiment, the width/thickness ratio of the rope is more than two, preferably more than 4.

In a preferred embodiment, the ropes are suspension ropes of an elevator.

In a preferred embodiment, over 50% of the surface area of the cross-section of the electrically conductive load bearing member is of the aforementioned conductive reinforcing fiber, preferably such that 50%-80% is of the aforementioned reinforcing fiber, more preferably such that 55%-70% is of the aforementioned reinforcing fiber, and substantially all the remaining surface area is of polymer matrix. In this way a good longitudinal stiffness for the electrically conductive load bearing member as well as good electrical conductivity are achieved. Most preferably, this is carried out such that approx. 60% of the surface area is of reinforcing fiber and approx. 40% is of matrix material (preferably epoxy material).

In a preferred embodiment, each said electrically conductive load bearing member extends parallel to the longitudinal direction of the rope unbroken throughout the length of the rope embedded in the non-conductive surface material.

The elevator is preferably such that the car thereof is arranged to serve two or more landings. The elevator preferably controls movement of the car in response to signals from user interfaces located at landing(s) and/or inside the car so as to serve persons on the landing(s) and/or inside the elevator car. Preferably, the car has an interior space suitable for receiving a passenger or passengers, and the car can be provided with a door for forming a closed interior space.

### BRIEF DESCRIPTION OF THE DRAWINGS

In the following, the present invention will be described in more detail by way of example and with reference to the attached drawings, in which

FIG. 1 illustrates an elevator according to an embodiment.

FIG. 2 illustrates details of the elevator of FIG. 1.

FIG. 3 illustrates preferred details of the counterweight of the elevator of FIG. 1.

FIG. 4 illustrates preferred details of the counterweight position sensor of FIGS. 2 and 3.

FIG. 5 illustrates preferred further details of the elevator of FIG. 1.

FIG. 6 illustrates a preferred cross section of the rope.

FIGS. 7 and 8 illustrate preferred details of the load bearing member of the rope.

The foregoing aspects, features and advantages of the invention will be apparent from the drawings and the detailed description related thereto.

### DETAILED DESCRIPTION

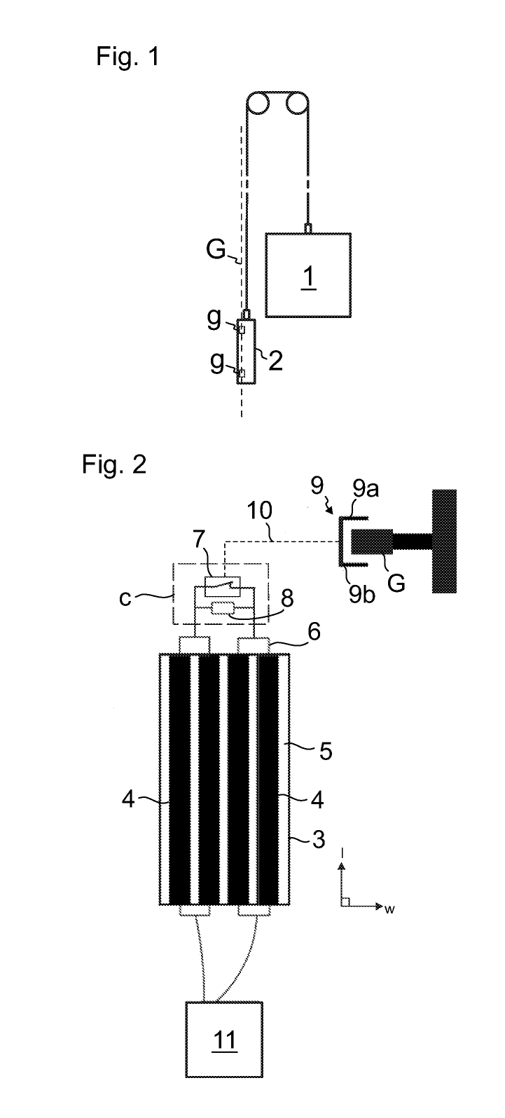

FIG. 1 illustrates an embodiment of an elevator according to a preferred embodiment. The elevator comprises an elevator car 1, a counterweight 2, and one or more ropes 3 interconnecting the car 1 and counterweight 2, one end of each rope 3 being fixed to the counterweight 2. The counterweight 2 is arranged to travel along guide rails G guided by guide members g mounted on the counterweight 2.

FIG. 2 illustrates further details of the elevator of FIG. 1. Each rope 3 comprise one or more electrically conductive load bearing members 4 that extend parallel to the longitudinal direction of the rope 3 unbroken throughout the length of the rope 3 embedded in a non-conductive surface material 5. The elevator comprises a monitoring circuit 6 comprising at least two of the load bearing members 4 of the one or more ropes 3 connected by one or more connectors 7, 8 in series, and one or more connectors 7, 8 mounted on the counterweight 2 and connecting ends of said at least two electrically conductive load bearing members 4 in series, said one or more connectors 7,8 comprising a switch 7 that is movable between a conductive and a non-conductive state, whereby the state change of the switch 7 is arranged to change conductivity of the monitoring circuit 6. In the preferred embodiment illustrated, said at least two electrically conductive load bearing members 4 connected by said one or more connectors 7, 8 in series are electrically conductive load bearing members of the same rope 3. However, this is not necessary as they could alternatively be electrically conductive load bearing members of the different ropes 3.

The elevator further comprises a counterweight position sensor 9 mounted on the counterweight 2. The counterweight position sensor 9 is arranged to sense position of the counterweight 2, in particular lateral position of the counterweight 2, i.e. position in horizontal direction, relative to guide rail G.

The switch 7 and the counterweight position sensor 9 are connected with each other with a connection 10, which connection 10 is preferably either a mechanical or an electrical connection, and the state of the switch 7 is arranged to change in response to position change of the counterweight 2 sensed by the counterweight position sensor 9.

The elevator comprises a monitoring system 11,100 connected with the monitoring circuit 6 and arranged to monitor the state of the monitoring circuit 6. The elevator, particularly said monitoring system 11,100 thereof, is arranged to perform one or more predetermined actions in response to state change of the monitoring circuit 6. Said one or more predetermined actions preferably include at least stopping the elevator car 1 and/or preventing further starts of the elevator car 1.

The elevator comprises a monitoring system 11,100 for monitoring the state of the circuit 6 and for performing one or more predetermined actions in response to state change of the monitoring circuit 6. Said monitoring system 11,100 preferably comprises a monitoring unit 11 connected with the monitoring circuit 6. It is preferably mounted on the elevator car 1. The monitoring unit 11 is preferably connected with the elevator control unit 100 of the elevator and/or a safety circuit of the elevator. Said state change of the circuit 9 is preferably a change in conductivity of the circuit 9. Preferably said monitoring system 11, 100 is arranged to monitor said state change of the circuit 9 by monitoring resistance of the circuit 9.

In the preferred embodiment, said counterweight position sensor 9 comprises one or more sensing members 9a, 9b arranged to travel together with the counterweight 2 along the guide rail G. Said one or more sensing members travel together with the counterweight along the guide rail out of contact with the guide rail. This is preferable because no wear is caused in normal situation. The sensing members can be arranged to sense mechanically the guide rail G position. Then, each of the sensing members is displaceable by the guide rail if the guide rail pushes the sensing member 9a, 9b when their relative position changes such that the sensing member in question moves towards the guide rail G.

In addition to said switch 7 said one or more connectors 7, 8 are made to include a further connector 8 parallel with the switch 7. Thus, said at least two of the load bearing members 4 are connected in series by plurality of connectors (7, 8) that are parallel with each other as illustrated in FIG. 2. As a result, state change of the circuit 6 caused by damaging of the load bearing members or cable disconnection are different from state change caused by derailment. This is advantageous, because this makes it possible to identify from the state change which of these causes (switch actuation or load bearing member damage or cable disconnection) has caused the occurred state change. Thus, it is possible to react appropriately to the state change depending on the cause. Said further connector 8 is preferably a resistor. The further connector 8 is however optional.

In case the further connector 8 is present, it is preferable that said one or more actions include one or more first actions in response to a first predetermined state change of the circuit 6, and one or more second actions in response to a second predetermined state change of the circuit 6, wherein said first and second predetermined state changes of the circuit 6 are different from each other. Preferably, said first predetermined change of the circuit 6 corresponds to drop of conductivity by a predetermined amount or a drop to a predetermined non-zero value, wherein said predetermined non-zero value is a value received with intact monitoring circuit said switch in open state. Preferably, said second predetermined change of the circuit 6 corresponds to drop of conductivity to zero or to some other non-zero value than said predetermined non-zero value. Then, preferably said one or more first actions include indicating that counterweight derailment has occurred and said one or more second actions include indicating that rope damage or cable disconnection has occurred. Both the first and second actions can further include stopping the elevator car 1 and/or preventing further starts of the elevator car 1 as mentioned earlier above.

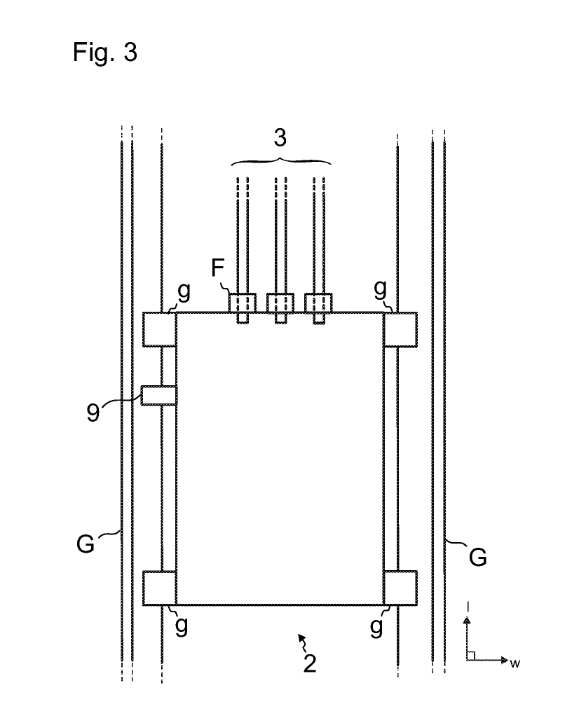

FIG. 3 illustrates preferred details of the counterweight arrangement. The end of each rope 3 has been fixed to the counterweight 2 with a rope fixing means F. The counterweight 2 has been mounted to travel along guide rails G guided by guide members g mounted on the counterweight 2. Each said guide member g may be any guide member suitable for leaning in horizontal direction against a vertical guide rail G and to travel along it. The guide members g are preferably either in the form of roller guides or slider guides, In the presented embodiment, there are two of said guide rails G, and two guide members g mounted on the counterweight 2 per each guide rail G. In the Figure, there is illustrated only one counterweight position sensor 9 mounted on the counterweight and arranged to sense position of the counterweight relative to a guide rail G. However, it is preferable that the elevator comprises per each guide rail G at least one counterweight position sensor 9 mounted on the counterweight and arranged to sense position of the counterweight relative to the guide rail G in question.

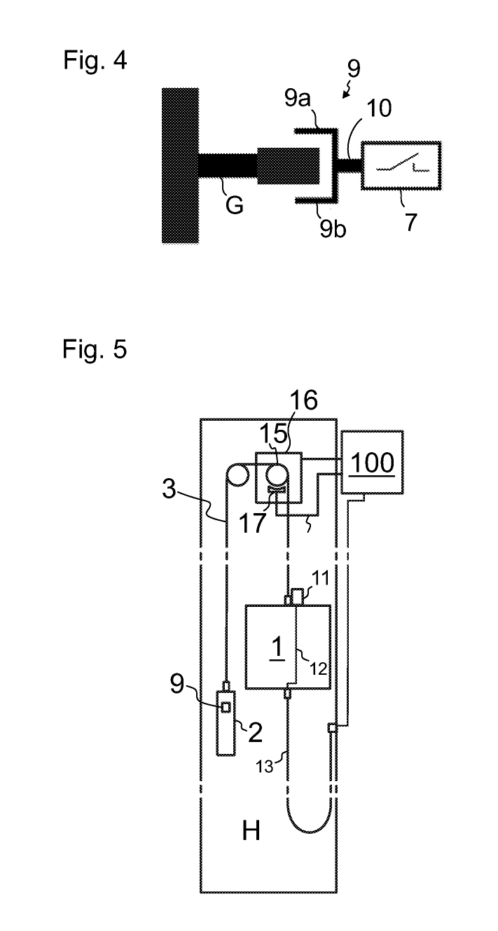

FIG. 4 illustrates preferred further details of the counterweight position sensor 9. In this case, the position sensor 9, in particular each of the sensing members thereof, is connected with the switch 7 by a mechanical linkage 10 by which the sensing member 9a, 9b is arranged to actuate the switch 7 to change its state when the sensing member 9a, 9b in question is displaced. The mechanical linkage 10 has been illustrated schematically. It can be implemented in various ways as it is apparent to the skilled person. It can contain for example one or more force transmission members connected to each other, such as one or more force transmission rods and/or one or more force transmission pivots for transmitting force from the counterweight position sensor 9 to the switch 7. The switch 7 on the other hand can in this case be any kind of known switch component that can be actuated by movement of a mechanical linkage. Accordingly, it can be a push button type of switch, a tactile switch or a toggle switch or any equivalent. There are of course also several other kinds of possible switches available for a skilled person.

FIG. 5 illustrates preferred further details of the elevator. The elevator comprises a hoistway H and said elevator car 1 and said counterweight vertically movable in the hoistway H. Each of said one or more ropes 3 pass around a drive wheel 15 mounted in proximity of the upper end of the hoistway H. In this case the drive wheel 15 is mounted inside the upper end of the hoistway H, but alternatively it could be mounted inside a space beside or above the upper end of the hoistway H, for example. There are of course also other alternative ways to provide the motive force to the car 1. The drive wheel 15 engages each of said ropes 3, and the elevator comprises a motor 16 for rotating the drive wheel 15. The elevator car 1 can be moved by rotating the drive wheel 15 engaging each of said ropes 3. The elevator comprises a control unit 100 for automatically controlling rotation of the motor M, whereby the movement of the car 1 is also made automatically controllable.

The elevator further comprises mechanical brakes 17 (machine brakes) for braking car movement. The mechanical brakes 17 are configured to act on the drive wheel 15 or a component fixed thereto when activated. Said stopping can include activation of the mechanical brakes 17 for stopping movement of the elevator car 1 and/or interruption of supply of electricity to the elevator motor 16. However the stopping can also be made gentle, such as by bringing the elevator car to a stop in a controlled fashion by controlling with a frequency controller of the control unit 100 the supply of electricity to the motor 16 such that the elevator car is brought to stop, such as to a stop at a nearest landing.

The elevator comprises a monitoring system 11,100 for monitoring the state of the circuit 6 presented in FIG. 2, and for performing one or more predetermined actions in response to state change of the monitoring circuit 6. As mentioned above, said monitoring system 11,100 preferably comprises a monitoring unit 11 mounted on the elevator car 1.

The monitoring unit 11 is preferably arranged to supply electricity to the circuit 6 so that change in conductivity of the monitoring circuit 6 state will be detectable as a drop in conductivity. The drop in conductivity can be detected by various alternative ways available in the electrical field.

Preferably, the monitoring unit 11 is connected with the elevator control unit 100 of the elevator over a connection 12,13, as illustrated in FIG. 5. In the presented case, said connection is partially formed by the traveling cable 13 of the elevator. Thus, the monitoring unit 11 can trigger the predetermined actions, e.g. said stopping of the elevator car by sending a signal to this effect to the elevator control unit 100. The monitoring unit 11 can be made sophisticated by making it comprise one or more microprocessors configured to monitor the state of the circuit 6, in particular conductivity thereof e.g. by monitoring one or more electrical properties of the circuit 6, such as its resistance or a voltage over it.

Said stopping can alternatively be triggered by braking of a safety circuit of the elevator. Safety circuit is a component of an elevator breaking of which is arranged to cause activation of mechanical brake(s) for stopping movement of the elevator car and/or interruption of supply of electricity to elevator motor 15. In this case, the monitoring unit 11 can be configured to brake the safety circuit in response to state change of the circuit 6 by a relay for example. The monitoring unit 11 can be made simple by making it comprise one or more relays for which the circuit 6 provides control current and which thereby have a position dependent on the conductivity of the circuit 6. The relay can be used to operate a safety switch of the safety circuit (not showed) of the elevator, for instance.

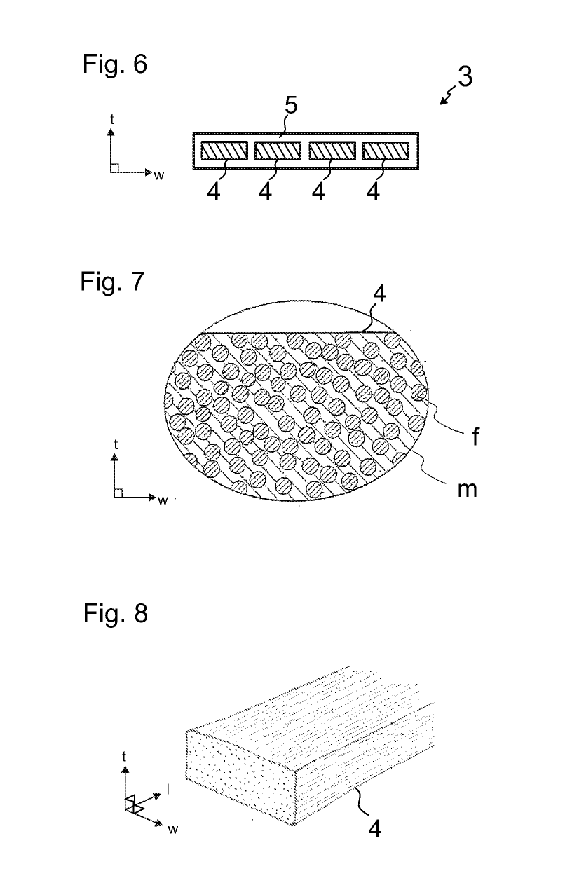

FIG. 6 illustrates a preferred structure of the rope 3. The rope 3 comprises one or more elongated load bearing members 4 that extend parallel to the longitudinal direction 1 of the rope 3 unbroken throughout the length of the rope 3. As illustrated, the load bearing members 4 are embedded in a non-conductive surface material 5 forming the outer surface of the rope 3. The non-conductive surface material 5 forms a coating adhering to the load bearing members 4. The non-conductive surface material 5 is preferably made of non-metallic material, such as polymer material, such as polyurethane for example.

With the non-conductive surface material 5, the load bearing members 4 are prevented from getting into contact with rope wheels or other components of the elevator that contact any of the lateral sides of the rope 3. Thus, the the non-conductive surface material 5 isolates the load bearing members 4 from external components whereby the conductivity monitored by the monitoring equipment is not disturbed. With the non-conductive surface material 5, i.e. the coating, the rope 3 is also provided with a surface via which the rope 3 can effectively engage frictionally with a drive wheel of an elevator, for instance. Also, hereby the friction properties and/or other surface properties of the rope are adjustable, independently of the load bearing function, such that the rope perform wells in the intended use, for instance in terms of traction for transmitting force in longitudinal direction of the rope so as to move the rope with a drive wheel. Furthermore, the load bearing members 4 embedded therein are thus provided with protection. The coating 5 is preferably elastic. Elastic polymer material, for example polyurethane provides the rope 3 the desired frictional properties simply, good wear resistance as well as efficient protection for the load bearing members 4. Polyurethane is in general well suitable for elevator use, but also materials such as rubber or silicon or equivalent elastic materials are suitable for the material of the coating 5.

In the embodiment illustrated in FIGS. 2 and 6, the rope R comprises plurality of the load bearing members 4, which are adjacent each other in width direction w of the rope R. In the present case, there are particularly four of said load bearing members 4 embedded adjacently in the non-conductive surface material 5, i.e. said coating 5. This is advantageous because thus, said at least two load bearing members 4 forming part of the circuit 6 can belong to the same rope 3, as presented in FIG. 2. In this case, said non-conductive surface material 5 isolates the at least two load bearing members 4 forming part of the circuit 6 from each other. However, the rope 3 could alternatively have any other number of load bearing members 4. For instance, the rope 3 could be made to have only one load bearing member 4, for instance. However, in this case the at least two load bearing members 4 forming part of the circuit 6 are to belong to different ropes 3.

Said load bearing members 4 are electrically conductive load bearing members. Preferably, they are made of composite material comprising electrically conductive reinforcing fibers embedded in polymer matrix, said reinforcing fibers preferably being carbon fibers. With this kind of structure, the rope 3 has especially advantageous properties in elevator use, such as light weight and good tensile stiffness in longitudinal direction but still good conductivity across the load bearing member 4. The structure of the rope can be more specifically as described in document WO2009090299A1. It is however not necessary that the load bearing members 4 are made of said composite, because the conductivity can be provided also by metallic load bearing members, such as metal cords.

FIG. 7 illustrates a preferred inner structure for the aforementioned electrically conductive load bearing member 4, showing inside the circle an enlarged view of the cross section of the load bearing member 4 close to the surface thereof, as viewed in the longitudinal direction 1 of the load bearing member 4. The parts of the load bearing member 4 not showed in FIG. 7 have a similar structure. FIG. 8 illustrates the load bearing member 4 three dimensionally. The load bearing member 4 is made of composite material comprising reinforcing fibers f embedded in polymer matrix m. The reinforcing fibers f are more specifically distributed at least substantially evenly in polymer matrix m and bound to each other by the polymer matrix m. This has been done e.g. in the manufacturing phase by immersing them together in the fluid material of the polymer matrix which is thereafter solidified. The load bearing member 4 formed is a solid elongated rod-like one-piece structure. Said reinforcing fibers f are most preferably carbon fibers, but alternatively they can be some other electrically conductive fibers. Preferably, the reinforcing fibers f of each load bearing member 4 are parallel with the longitudinal direction of the load bearing member 4. Thereby, the fibers f are also parallel with the longitudinal direction of the rope 3 as each load bearing member 4 is oriented parallel with the longitudinal direction of the rope 3. This is advantageous for the rigidity as well as behavior in bending. Owing to the parallel structure, the fibers in the rope 4 will be aligned with the force when the rope R is pulled, which ensures that the structure provides high tensile stiffness. The fibers f used in the preferred embodiments are accordingly substantially untwisted in relation to each other, which provides them said orientation parallel with the longitudinal direction of the rope 3. All the reinforcing fibers f are preferably distributed in the aforementioned load bearing member 4 at least substantially evenly. The fibers f are then arranged so that the load bearing member 4 would be as homogeneous as possible in the transverse direction thereof. The composite matrix m, into which the individual fibers f are distributed, is most preferably made of epoxy, which has good adhesiveness to the reinforcement fibers f and which is known to behave advantageously with reinforcing fibers such as carbon fiber particularly. Alternatively, e.g. polyester or vinyl ester can be used, but any other suitable alternative materials can be used. The polymer matrix m is preferably of a hard non-elastomer, such as said epoxy, as in this case a risk of buckling can be reduced for instance. However, the polymer matrix need not be non-elastomer necessarily, e.g. if the downsides of this kind of material are deemed acceptable or irrelevant for the intended use. In that case, the polymer matrix m can be made of elastomer material such as polyurethane or rubber for instance.

Preferably over 50% of the surface area of the cross-section of the electrically conductive load bearing member 4 is of the aforementioned conductive reinforcing fiber f, preferably such that 50%-80% is of the aforementioned reinforcing fiber, more preferably such that 55%-70% is of the aforementioned reinforcing fiber, and substantially all the remaining surface area is of polymer matrix. Most preferably, this is carried out such that approx. 60% of the surface area is of reinforcing fiber and approx. 40% is of matrix material (preferably epoxy material). In this way a good longitudinal stiffness for the load bearing member 4 as well as good electrical conductivity are achieved.

Preferably, the electrically conductive load-bearing member(s) of the rope cover(s) over proportion 50% of the cross-section of the rope. Thereby, a high tensile stiffness can be facilitated.

Preferably, the electrically conductive load-bearing member(s) of the rope cover(s) majority, preferably 60% or over, more preferably 65% or over of the width of the rope. In this way at least majority of the width of the rope will be effectively utilized and the rope can be formed to be light and thin in the bending direction for reducing the bending resistance.

In the preferred embodiments, an advantageous structure for the rope 3 has been disclosed. However, the invention can be utilized with also other kind of ropes such as with other kinds of belt-shaped ropes having different materials and/or shapes. Also, the ropes could be shaped otherwise than disclosed, such as to have a round in cross section instead of belt-shape, for example.

The aforementioned at least two electrically conductive load bearing members 4 that are connected in series are preferably arranged to extend parallel each other in the elevator as illustrated in FIGS. 2 and 6. However, this is not necessary as alternatively they could be arranged in twisted configuration.

It is to be understood that the above description and the accompanying Figures are only intended to teach the best way known to the inventors to make and use the invention. It will be apparent to a person skilled in the art that the inventive concept can be implemented in various ways. The above-described embodiments of the invention may thus be modified or varied, without departing from the invention, as appreciated by those skilled in the art in light of the above teachings. It is therefore to be understood that the invention and its embodiments are not limited to the examples described above but may vary within the scope of the claims.

1. An elevator comprising:
an elevator car;
a counterweight;
one or more ropes interconnecting the car and counterweight, one end of each rope being fixed to the counterweight, and each rope comprising one or more electrically conductive load bearing members that extend unbroken throughout the length of the rope embedded in a non-conductive surface material;
a monitoring circuit comprising at least two of said electrically conductive load bearing members of the one or more ropes connected in series, and one or more connectors mounted on the counterweight and connecting ends of said at least two electrically conductive load bearing members in series, said one or more connectors comprising a switch that is movable between a conductive and a non-conductive state, whereby the state change of the switch is arranged to change conductivity of the monitoring circuit;
a monitoring system connected with the monitoring circuit and arranged to monitor the state of the monitoring circuit; and
a counterweight position sensor mounted on the counterweight, and arranged to sense position of the counterweight,
wherein the switch and the counterweight position sensor are connected, and the state of the switch is arranged to change in response to position change of the counterweight sensed by the counterweight position sensor, and
wherein the elevator is arranged to perform one or more predetermined actions in response to a state change of the monitoring circuit.

2. The elevator according to claim 1, wherein said one or more predetermined actions include at least stopping the elevator car and/or preventing further starts of the elevator car.

3. The elevator according to claim 1, wherein the monitoring system is arranged to perform said one or more predetermined actions in response to state change of the monitoring circuit.

4. The elevator according to claim 1, wherein the monitoring system is arranged to supply electricity to the monitoring circuit.

5. The elevator according to claim 1, wherein the monitoring system comprises a monitoring unit connected with the monitoring circuit and arranged to supply electricity to the monitoring circuit.

6. The elevator according to claim 5, wherein said monitoring unit is mounted on the elevator car.

7. The elevator according to claim 1, wherein said counterweight position sensor is arranged to sense a lateral position of the counterweight relative to a guide rail guided by which the counterweight is arranged to travel.

8. The elevator according to claim 1, wherein said counterweight position sensor comprises one or more sensing members arranged to travel together with the counterweight along the guide rail.

9. The elevator according to claim 8, wherein said one or more sensing members travel together with the counterweight along the guide rail out of contact with the guide rail.

10. The elevator according to claim 8, wherein each of the sensing members is displaceable by the guide rail if the guide rail pushes the sensing member.

11. The elevator according to claim 8, wherein each of the sensing members is connected with the switch by a mechanical linkage by which the sensing member is arranged to actuate the switch to change its state when the sensing member is displaced.

12. The elevator according to claim 1, wherein each said rope is belt-shaped and comprises plurality of electrically conductive load bearing members adjacent each other in width direction of the rope, isolated from each other by the non-conductive surface material, and said at least two electrically conductive load bearing members belong to the same rope.

13. The elevator according to claim 1, wherein each said electrically conductive load bearing member is made of a composite material comprising electrically conductive reinforcing fibers embedded in a polymer matrix.

14. The elevator according to claim 1, wherein said one or more connectors include a further connector parallel with the switch.

15. The elevator according to claim 14, wherein said one or more actions include one or more first actions in response to a first predetermined state change, and one or more second actions in response to a second predetermined state change, wherein said first and second predetermined state changes are different from each other.

16. The elevator according to claim 1, wherein each said electrically conductive load bearing member is made of a composite material comprising electrically conductive reinforcing fibers embedded in a polymer matrix, said electrically conductive reinforcing fibers being carbon fibers.

17. The elevator according to claim 1, wherein said one or more connectors include a further connector parallel with the switch, said further connector being a resistor.

18. The elevator according to claim 2, wherein the monitoring system is arranged to perform said one or more predetermined actions in response to a state change of the monitoring circuit.

19. The elevator according to claim 2, wherein the monitoring system is arranged to supply electricity to the monitoring circuit.

20. The elevator according to claim 3, wherein the monitoring system is arranged to supply electricity to the monitoring circuit.
